(19) United States
(12) Patent Application Publication
(10) Pub. No.: US 2025/0344231 A1
(43) Pub. Date: Nov. 6, 2025

(54) INTERNET OF THINGS INVENTORY PROCEDURES

(71) Applicant: Lenovo (United States) Inc., Morrisville, NC (US)

(72) Inventor: Hyung-Nam Choi, Ottobrunn (DE)

(21) Appl. No.: 19/267,132

(22) Filed: Jul. 11, 2025

(51) Int. Cl. H04W 72/51; G16Y 10/75

(52) U.S. Cl. CPC H04W 72/51; G16Y 10/75

(57) ABSTRACT

Various aspects of the present disclosure relate to methods, apparatuses, and devices for wireless communication. An ambient internet of things (AIoT) reader may be configured to, capable of, or operable to transmit, to at least one AIoT device, a first message associated with an AIoT procedure, wherein the first message comprises at least one parameter associated with a request for a shortened representation of device identifier information associated with the at least one AIoT device. The AIoT reader may be configured to, capable of, or operable to receive, from the at least one AIoT device, a second message including the device identifier information associated with the at least one AIoT device.

### TECHNICAL FIELD

The present disclosure relates to wireless communications, and more specifically to internet of things (IoT) procedures in a wireless communications system.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, including in the claims, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Various aspects of the present disclosure relate to wireless communications, including improved network entities, processors, and methods for performing operations with multiple carriers in a wireless communications system.

An ambient internet of things (AIoT) reader for wireless communication is described. The AIoT reader may be configured to, capable of, or operable to transmit, to at least one AIoT device, a first message associated with an AIoT procedure, wherein the first message comprises at least one parameter associated with a request for a shortened representation of device identifier information associated with the at least one AIoT device. The AIoT reader may be configured to, capable of, or operable to receive, from the at least one AIoT device, a second message including the device identifier information associated with the at least one AIoT device.

A processor (e.g., (e.g., a standalone processor chipset, or a component of an AIoT reader) for wireless communication is described. The processor may be configured to, capable of, or operable to transmit, to at least one AIoT device, a first message associated with an AIoT procedure, wherein the first message comprises at least one parameter associated with a request for a shortened representation of device identifier information associated with the at least one AIoT device. The processor may be configured to, capable of, or operable to receive, from the at least one AIoT device, a second message including the device identifier information associated with the at least one AIoT device.

A method performed or performable by an AIoT reader for wireless communication is described. The method may include transmitting, to at least one AIoT device, a first message associated with an AIoT procedure, wherein the first message comprises at least one parameter associated with a request for a shortened representation of device identifier information associated with the at least one AIoT device. The method may include receiving, from the at least one AIoT device, a second message including the device identifier information associated with the at least one AIoT device.

An AIoT device for wireless communication is described. The AIoT device may be configured to, capable of, or operable to receive, from an AIoT reader, a first message associated with an AIoT procedure, wherein the first message comprises at least one parameter associated with a request for a shortened representation of device identifier information associated with the AIoT device. The AIoT device may be configured to, capable of, or operable to transmit, to the AIoT reader, a second message including the device identifier information associated with the AIoT device.

A processor (e.g., a standalone processor chipset, or a component of an AIoT device) for wireless communication is described. The processor may be configured to, capable of, or operable to receive, from an AIoT reader, a first message associated with an AIoT procedure, wherein the first message comprises at least one parameter associated with a request for a shortened representation of device identifier information associated with the AIoT device. The processor may be configured to, capable of, or operable to transmit, to the AIoT reader, a second message including the device identifier information associated with the AIoT device.

A method performed or performable by an AIoT device for wireless communication is described. The method may include receiving, from an AIoT reader, a first message associated with an AIoT procedure, wherein the first message comprises at least one parameter associated with a request for a shortened representation of device identifier information associated with the AIoT device. The method may include transmitting, to the AIoT reader, a second message including the device identifier information associated with the AIoT device.

### BRIEF DESCRIPTION OF THE DRAWINGS

FIG. 1 illustrates an example of a wireless communications system in accordance with aspects of the present disclosure.

FIGS. 2 and 3 illustrate examples of an inventory procedure in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by an AIoT reader in accordance with aspects of the present disclosure.

FIG. 8 illustrates a flowchart of a method performed by an AIoT device in accordance with aspects of the present disclosure.

### DETAILED DESCRIPTION

Some wireless communication systems, including those involving one or more UEs, base stations, or other network entities, may support operations involving AIoT devices. AIoT devices represent a new class of ultra-low complexity, ultra-low power IoT devices deployed for low-end applications, such as inventory tracking, sensor data collection, and actuator control. These devices may operate without batteries, relying solely on ambient energy harvesting sources (e.g., from radio waves, light, motion, or heat). In some cases, procedures involving such devices may be inefficient due to factors such as variable-length identifier transmissions, lack of security protection, or limited availability of resources (e.g., time-frequency resources and the like). For example, transmitting complete AIoT device identifiers may increase an ON time, increase bandwidth usage, and increase energy demands, thereby reducing the suitability of large-scale or resource-constrained AIoT deployments.

Various aspects of the present disclosure relate to enabling one or more UEs, base stations, network entities, or the like to support improved procedures for AIoT devices by reducing the ON time (e.g., an active transmission duration) associated with respective uplink messages. In some examples, one or more UEs, base stations, or network entities may be configured to initiate or manage AIoT operations by transmitting paging messages that request shortened versions of device identifiers. Additionally, or alternatively, one or more UEs, base stations, or network entities may be configured to allocate (e.g., schedule) resources based at least in part on an expected identifier length, a service area coverage, and/or security requirements. By reducing the ON time for AIoT devices through the use of shortened device identifiers and efficient message formats, one or more entities may achieve lower signaling overhead, reduced power consumption, improved spectral efficiency, and yield ultra-low power device operation in AIoT deployment.

Aspects of the present disclosure are described in the context of a wireless communications system.

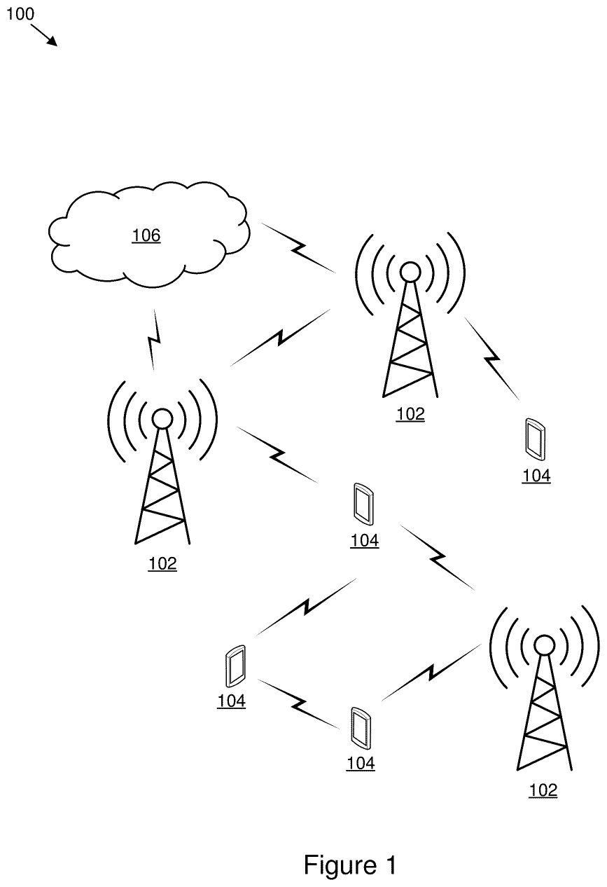

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N3, N6 or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communication system 100, one or more UEs 104 may be an AIoT device. The wireless communication system 100 may support various frameworks (also referred to as topologies) for AIoT. In some examples, the wireless communication system 100 may support a Deployment Scenario 1, Topology 1 (DIT1). DIT1 may involve indoor environments, such as warehouses, factories, shopping malls, airport terminals, or homes, where AIoT devices may communicate directly and bidirectionally with a base station reader (e.g., one or more NE 102).

In an AIoT framework, support may be provided for traffic types such as device-triggered (DT) and device-originated (DO)-device-triggered transmission (DTT) for Type 1 AIoT devices. These devices may be passive, with peak power consumption on the order of 1 μW, incorporating energy storage components and lacking both downlink and uplink amplification. Uplink transmission may be performed via backscattering, wherein the devices modulate and reflect an externally provided carrier wave. The energy storage mechanism for these devices, typically capacitors, may vary in capacity depending on the implementation. As a result, each device may operate independently for a limited duration during inventory or command procedures without continuous energy harvesting.

AIoT procedures may support at least two use cases: an inventory-only use case and an inventory-and-command use case. Inventory may involve identifying one or more AIoT devices, while command operations may include read, write, control, enable, or disable functions targeting one or more AIoT devices. The AIoT reader may trigger the inventory procedure by sending a paging message to one or more AIoT devices.

Two system architecture solutions may be supported in an AIoT framework: an AIoT function (AIOTF) may communicate directly with an AIoT radio access network (RAN) node to perform AIoT operations and/or the AIOTF may communicate indirectly with the AIoT RAN node via a core network entity (e.g., an AMF). In some examples, the AIOTF or an application function (AF) may provide one or more parameters for inclusion in the paging message.

An AIoT RAN node may include: a reader function, which may handle communication with AIoT devices via the AIoT radio interface and/or a radio resource control function, which may manage the AIoT radio resources allocated to each device. The AIoT RAN node may support one or more base station readers and may coordinate their usage of radio resources. Each base station reader may serve a defined service area.

The maximum payload size for Device-to-Reader (D2R) and Reader-to-Device (R2D) messages transmitted over the AIoT radio interface may be limited, for example to 1000 bits.

Each AIoT device may be configured with a globally unique permanent identifier, which may be allocated by a network operator or by a third party. The size of this identifier may vary depending on the allocation scheme. In some cases, only a portion of the identifier, i.e., a shortened representation that may be truncated or non-truncated, referred to as short identification information, may be used during communication.

AIoT operations, such as inventory and command procedures, may be performed for one or more devices. Each of the UEs 104 of FIG. 1 may correspond to one or more AIoT devices. Each AIoT device may send an inventory response containing its permanent identifier. The NEs 102 may function as a reader that may allocate the radio resources for transmitting the D2R inventory response in a paging message that triggers the procedure. However, the following issues may arise: the size of the inventory response for each device may vary, as the length of the permanent identifier is variable; the inventory response may not be security-protected—that is, it may be sent in plaintext; the allowable size of a D2R message may be constrained by the target service area coverage—for example, when physical layer (PHY) repetitions are required, the supported message size may be reduced to 400 bits or less; and/or the inventory response may include additional control information, such as a transaction identifier, reader identifier, or other metadata. This additional information may further reduce the available payload size. To improve efficiency and reduce device energy usage, the AIoT device may include a short device ID in the inventory response.

Therefore, the AIoT RAN node may not always be able to allocate sufficient radio resources to accommodate the complete permanent identifier. For security or efficiency reasons, it may also be unnecessary to transmit the full permanent identifier. As a result, it may be advantageous to support the use of shortened device identifiers in inventory responses, consistent with radio interface limitations and security requirements. The short device identifier may be a shortened representation comprising a complete or truncated version of the identification information in the AIoT device permanent identifier. The device may perform truncation based on parameters received from the AIoT reader.

To enable the transfer of short device identifiers in inventory responses, there may be extensions in a paging message, a change in context of an inventory response, and/or extensions in an inventory request message and a service request message. The AIoT reader may receive the relevant parameters (e.g., length or type of identifier to request) from an AIoT network entity such as an AIOTF or AF. The paging message may include one or more parameters such as the length and/or type of requested device ID information.

To extend a paging message, a parameter may indicate the length of the identification information in the paging ID, for example, one of {96, 128, 196, 256, 496} bits. See the parameter “Length of identification information in paging ID” in Table 1.

Additional parameters may indicate both the length and type of the device identifier requested in the inventory response. These may include: “Length of requested device ID information in inventory response” and “Type of requested device ID information in inventory response” as shown in Table 1.

TABLE 1
Content of the Paging message that is sent by the AIoT reader to the AIoT device

| Parameter | Size | | Description |
|---|---|---|---|
| Message type | A | bits | Used to indicate that the R2D message |
| | | | contains the paging message. |
| Transaction ID | B | bits | Used to indicate to which service |
| | | | request the Paging message is |
| | | | associated to. |
| Reader ID | C | bits | Used to identify the AIoT reader that |
| | | | sends the Paging message. |
| RA type indication | 1 | bit | Used to indicate whether to perform |
| | | | the inventory procedure using CBRA |
| | | | or CFRA. |
| Radio resource | D | bits | |
| configuration for Msg1, | | | |
| Msg2 and/or inventory | | | |
| response | | | |
| Type of paging ID | 1 | bit | Used to indicate whether the paging |
| | | | ID contains an AIoT device permanent |
| | | | identifier or filtering information. |
| Length of paging ID | 10 | bits | |
| Paging ID | E | bits | |
| Length of identification | 10 | bits | |
| information in paging ID | | | |
| Length of requested device | 10 | bits | |
| ID information in inventory | | | |
| response | | | |
| Type of requested device ID | 1 | bit | Used to indicate which type of device |
| information in inventory | | | ID information is requested in the |
| response | | | inventory response, i.e. either the |
| | | | AIoT device permanent identifier or |
| | | | the identification information in the |
| | | | AIoT device permanent identifier. |
| Padding | F | bits | If needed, used to fill the remaining |
| | | | space in the Paging message with |
| | | | value “0”. |

To change a context of an inventory response, parameters may be used to indicate the length and type of device ID information that is contained in the inventory response, see parameters “Length of device ID information” and “Type of device ID information” as shown in Table 2.

TABLE 2
Content of the inventory response in the D2R message
that is sent by the AIoT device to the AIoT reader

| Parameter | Size | | Description |
|---|---|---|---|
| Message type | G | bits | Used to indicate that the D2R message |
| | | | contains the inventory response. |
| Transaction ID | B | bits | Used to indicate to which service |
| | | | request/Paging message the inventory |
| | | | response is sent. |
| Reader ID | C | bits | Used to identify the AIoT reader the |
| | | | inventory response is sent. |
| Length of device ID | 10 | bits | |
| information | | | |
| Type of device ID | 1 | bit | Used to indicate whether the device ID |
| information | | | information contains either the AIoT |
| | | | device permanent identifier or the |
| | | | identification information in the AIoT |
| | | | device permanent identifier. |
| Device ID | H | bits | |
| information | | | |
| Padding | I | bits | If needed, used to fill the remaining |
| | | | space in the inventory response with |
| | | | value “0”. |

For extensions in the inventory request message and service request message, parameters may be used to indicate the length and type of requested device ID information in inventory response, see parameters “Length of requested device ID information in inventory response” and “Type of requested device ID information in inventory response” as shown in Table 3.

TABLE 3
Content of the Inventory Request message (sent
by the AIOTF to the AIoT RAN node) and Service
Request message (sent by the AF to AIOTF)

| Parameter | Size | Description |
|---|---|---|
| Length of requested | 10 bits | |
| device ID information in | | |
| inventory response | | |
| Type of requested device | 1 bit | Used to indicate which type of device |
| ID information in | | ID information is requested in the |
| inventory response | | inventory response, i.e. either the |
| | | AIoT device permanent identifier or |
| | | the identification information in the |
| | | AIoT device permanent identifier. |

The proposed enhancements may enable both the AIoT network and the AIoT devices to support flexible and secure transmission of shortened device identifiers in inventory responses. This capability is particularly beneficial in scenarios where radio interface constraints or privacy considerations make it impractical to transmit the full permanent identifier. By explicitly specifying the desired length and type of identifier data, the system may adapt dynamically to the resource availability, coverage conditions, and security requirements of a given deployment.

In one embodiment, there may be a transfer of a short non-truncated device ID in an inventory response. The following assumptions may apply to this embodiment. There may be multiple AIoT devices, e.g., 1 to N and of type 1, located within a service area and served by a single AIoT reader (base station reader) that is part of an AIoT RAN node. The system may operate under an architecture solution in which the AIOTF communicates directly with the AIoT RAN node to carry out AIoT operations. Within this setup, the maximum size of D2R messages transmitted over the AIoT radio interface may be limited to 400 bits. Certain devices may be configured by the operator with unique AIoT device permanent identifiers of 356 bits, which include 256 bits of identification information. Other devices may be configured with permanent identifiers of 228 bits, including 128 bits of identification information. All AIoT devices, e.g., 1 to N, may have previously undergone an inventory process, and their permanent identifiers along with their known locations are stored in the operator's AIoT Device Management (ADM) system. An Application Function (AF) may seek to re-inventory devices to verify their continued presence within their originally inventoried locations. The inventory procedure may be conducted using contention-based random access (CBRA). For this operation, no security protection of the inventory response is required, meaning the complete device ID information may be transmitted by devices in their inventory responses.

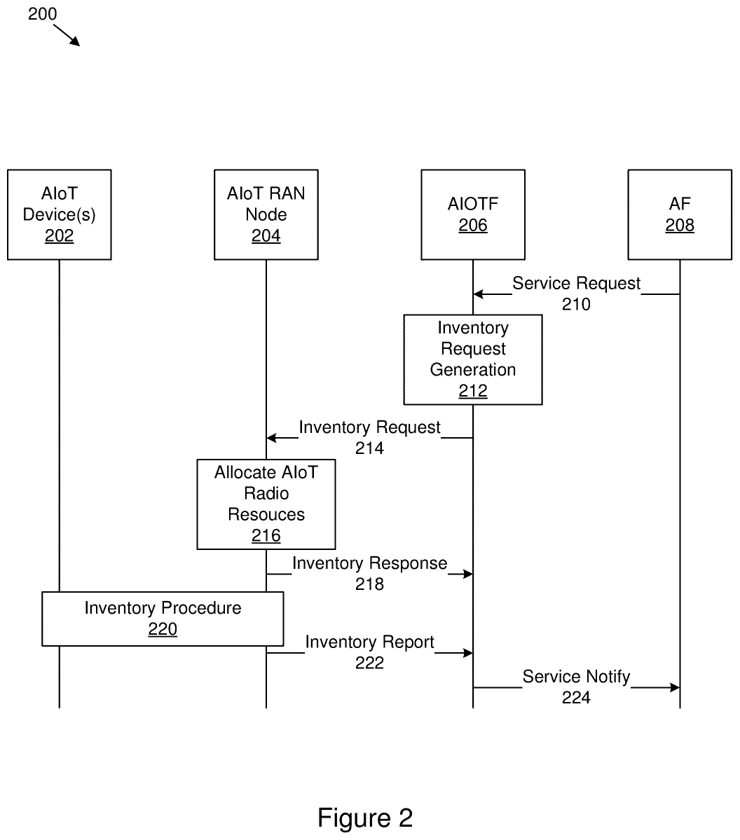

FIG. 2 illustrates an example of an inventory procedure 200 in accordance with aspects of the present disclosure. In some examples, the inventory procedure 200 implements or is implemented by aspects of the wireless communications system 100. The inventory procedure 200 may implement or be implemented by one or more devices (e.g., UEs, NEs). For example, the inventory procedure 200 may include one or more AIoT devices 202, an AIoT RAN node 204, an AIOTF 206, and an AF 208. Alternative examples of the following may be implemented, where some processes are performed in a different order than described or are not performed. In some cases, processes may include additional features not mentioned below, or further processes may be added.

At step 210, the AF 208 may transmit (e.g., send, output), and the AIOTF 206 may receive (e.g., obtain), a service request message to retrieve a respective identity of one or more targets (e.g., objects, items, components, or the like), which may be located in a service area and to which the AIoT devices are attached (e.g., coupled to, mounted on, etc.). The service request message may include (e.g., contain) information about the service area and filtering information of the AIoT devices 202. The filtering information may be applied to identification information in an AIoT device permanent identifier of each AIoT device 202. The filtering information may have a length of 178 bits, comprising: 9 bits to indicate an offset within the identification information bitstring to be compared, 9 bits to indicate a length of a segment of the bitstring to be compared, and 160 bits representing a segment of the identification information's bitstring to be compared. In addition, the service request message may include one or more parameters, including “a length of a requested device ID information in inventory response set to 256 bits, and “a type of requested device ID information in inventory response” set to the identification information in the AIoT device permanent identifier.

At step 212, upon reception of the service request message, the AIOTF 206 checks the parameters included in the message. If the check of the parameters is successful, then the AIOTF 206 generates an inventory request message.

At step 214, the AIOTF 206 sends the inventory request message to the AIoT RAN node 204 that serves the target service area and the target AIoT devices 202. The message includes filtering information of the target AIoT devices 202 and the length/type of requested device ID information in inventory response.

At step 216, the AIoT RAN node 204 allocates AIoT radio resources for the AIoT inventory procedure.

At step 218, the AIoT RAN node 204 sends an inventory response message to the AIOTF 206 indicating that the inventory procedure will be initiated towards the target AIoT devices 202.

At step 220, the AIoT reader of the AIoT RAN node 204 sends a paging message to the target AIoT devices 202 to perform the inventory procedure based on CBRA. The paging message may contain the following parameter settings: “Length of identification information in paging ID” set to 256 bits, “Length of requested device ID information in inventory response” set to 256 bits, and “Type of requested device ID information in inventory response” set to the identification information in the AIoT device permanent identifier.

Certain target AIoT devices 202 may determine that they have been selected for the inventory procedure. As result, they send the requested device ID information in the inventory response. The inventory response may include the following information: “Length of device ID information” set to 256 bits, “Type of device ID information” set to the identification information in the AIoT device permanent identifier, and “Device ID information” set to the 256-bits long identification information in the AIoT device permanent identifier.

At step 222, after receiving the inventory result, i.e. the requested device ID information from certain target AIoT devices 202, the AIoT RAN node 204 sends an inventory report message to the AIOTF 206 including the inventory result received from certain target AIoT devices 202.

At step 224, when receiving the inventory report message, the AIOTF 206 sends a service notify message to the AF 208 including the received device ID information.

In another embodiment, there may be a transfer of a short truncated device ID in an inventory response. The following assumptions may apply to this embodiment. There may be multiple AIoT devices, e.g., 1 to N and of type 1, located within a service area and served by a single AIoT reader (base station reader) that is part of an AIoT RAN node. The system may operate under an architecture solution in which the AIOTF communicates directly with the AIoT RAN node to carry out AIoT operations. Within this setup, the maximum size of D2R messages transmitted over the AIoT radio interface may be limited to 400 bits. Certain devices may be configured by the operator with unique AIoT device permanent identifiers of 356 bits, which include 256 bits of identification information. Other devices may be configured with permanent identifiers of 228 bits, including 128 bits of identification information. All AIoT devices, e.g., 1 to N, may have previously undergone an inventory process, and their permanent identifiers along with their known locations are stored in the operator's ADM system. An AF may seek to re-inventory devices to verify their continued presence within their originally inventoried locations. The inventory procedure may be conducted using CBRA. For this operation, security protection of the inventory response is required, meaning truncated device ID information is transmitted by devices in their inventory responses.

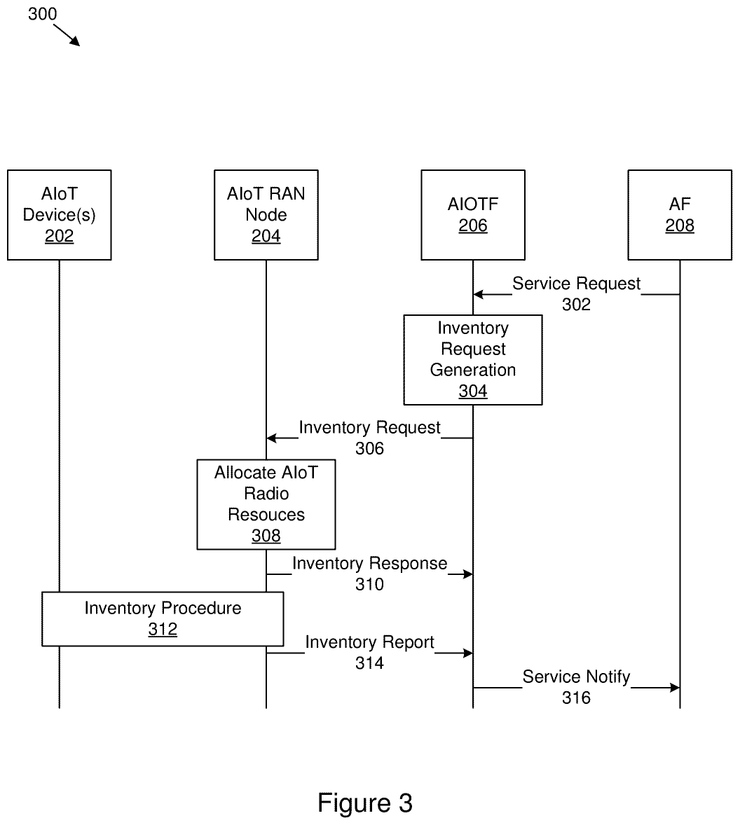

FIG. 3 illustrates an example of a second inventory procedure 300 in accordance with aspects of the present disclosure. The second inventory procedure 300 includes the AIoT devices 202, the AIoT RAN node 204, the AIOTF 206, and the AF 208. The steps in the second inventory procedure 300 may be performed in a different order than shown and may include fewer or more steps.

At step 302, the AF 208 sends a service request message to the AIOTF 206 to retrieve the identity of objects that are located in the target service area and to which AIoT devices are attached. The service request message contains information about the target service area and filtering information of the target AIoT devices 202. The filtering information is applied to the identification information in the AIoT device permanent identifiers. The length of the filtering information is 178 bits: 9 bits for indicating the offset of the identification information's bitstring to be compared, 9 bits for indicating the length of the identification information's bitstring to be compared, and 160 bits of the identification information's bitstring to be compared. In addition, the service request message contains the following parameters: “Length of requested device ID information in inventory response” set to 160 bits, and “Type of requested device ID information in inventory response” set to the identification information in the AIoT device permanent identifier.

At step 304, upon reception of the service request message, the AIOTF 206 checks the parameters included in the message. If the check of the parameters is successful, then it generates an inventory request message.

At step 306, the AIOTF 206 sends an inventory request message to the AIoT RAN node 204 that serves the target service area and the target AIoT devices 202. The message includes filtering information of the target AIoT devices 202 and the length/type of requested device ID information in inventory response.

At step 308, the AIoT RAN node 204 allocates AIoT radio resources for the AIoT inventory procedure.

At step 310, the AIoT RAN node 204 sends an inventory response message to the AIOTF 206 indicating that the inventory procedure will be initiated towards the target AIoT devices 202.

At step 312, the AIoT reader of the AIoT RAN node 204 sends a paging message to the target AIoT devices 202 to perform the inventory procedure based on CBRA. The paging message contains the following parameter settings: “Length of identification information in paging ID” set to 256 bits, “Length of requested device ID information in inventory response” set to 160 bits, and “Type of requested device ID information in inventory response” set to the identification information in the AIoT device permanent identifier.

Certain target AIoT devices 202 determine that they have been selected for the inventory procedure. As result, they send the requested device ID information in the inventory response. The inventory response contains the following information: “Length of device ID information” set to 160 bits, “Type of device ID information” set to the identification information in the AIoT device permanent identifier, and “Device ID information” set to the 160-bits long identification information in the AIoT device permanent identifier. That means certain target AIoT devices 202 send truncated device ID information in the inventory response. Certain target AIoT devices 202 truncate their identification information by sending only 160 bits of the 256 bits (e.g., starting from the LSB or MSB). The AIoT device may determine how to truncate the identification information based at least in part on the received parameters.

At step 314, after receiving the inventory result, i.e. the requested device ID information from certain target AIoT devices 202, the AIoT RAN node 204 sends an inventory report message to the AIOTF 206 including the inventory result received from certain target AIoT devices 202.

At step 316, when receiving the inventory report message, the AIOTF 206 sends a service notify message to the AF 208 including the received device ID information.

After receiving the truncated device ID information from certain target AIoT devices 202, the AF 208 may initiate a read-command procedure to retrieve the complete AIoT device permanent identifiers or the complete identification information in the AIoT device permanent identifier of certain target AIoT devices 202.

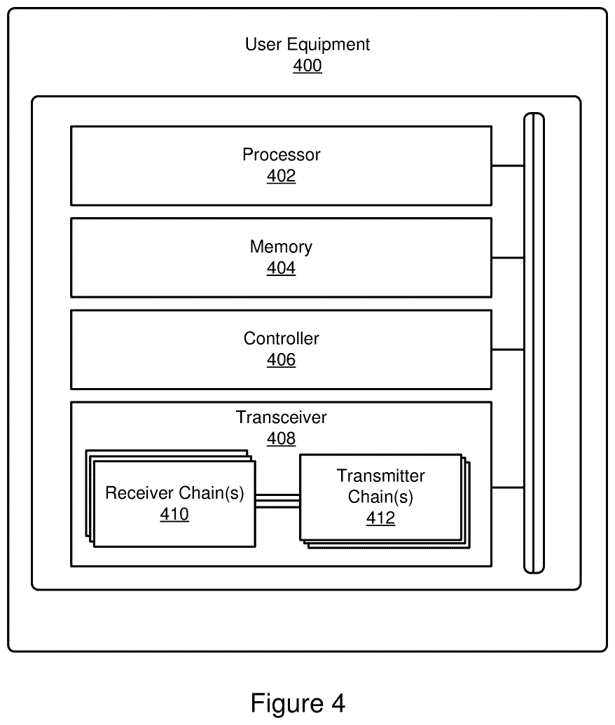

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, a field programmable gate array (FPGA), or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. For example, the processor 402 coupled with the memory 404 may be configured to cause the UE 400 to: receive, from an AIoT reader, a first message associated with an AIoT procedure, wherein the first message comprises at least one parameter associated with a request for a shortened representation of device identifier information associated with the AIoT device; and transmit, to the AIoT reader, a second message including the device identifier information associated with the AIoT device.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like PSK or QAM. The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

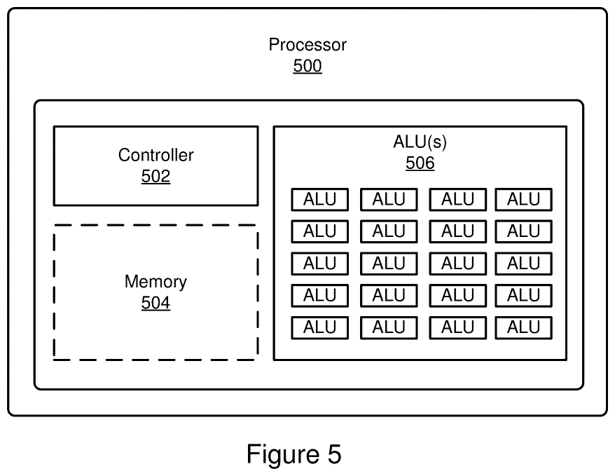

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for performing various operations described herein. For example, the processor 500 may be configured to: receive, from an AIoT reader, a first message associated with an AIoT procedure, wherein the first message comprises at least one parameter associated with a request for a shortened representation of device identifier information associated with the AIoT device; and transmit, to the AIoT reader, a second message including the device identifier information associated with the AIoT device.

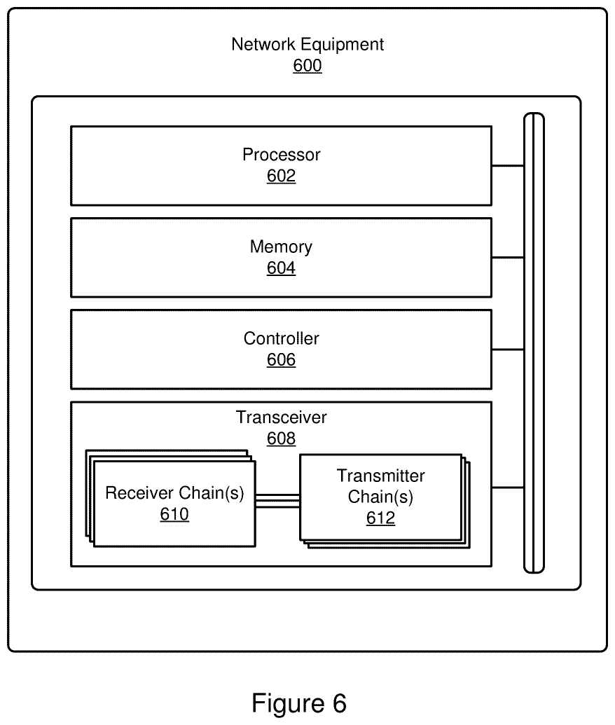

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure. For example, the processor 602 coupled with the memory 604 may be configured to cause the NE 600 to: transmit, to at least one AIoT device, a first message associated with an AIoT procedure, wherein the first message comprises at least one parameter associated with a request for a shortened representation of device identifier information associated with the at least one AIoT device; and receive, from the at least one AIoT device, a second message including the device identifier information associated with the at least one AIoT device.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

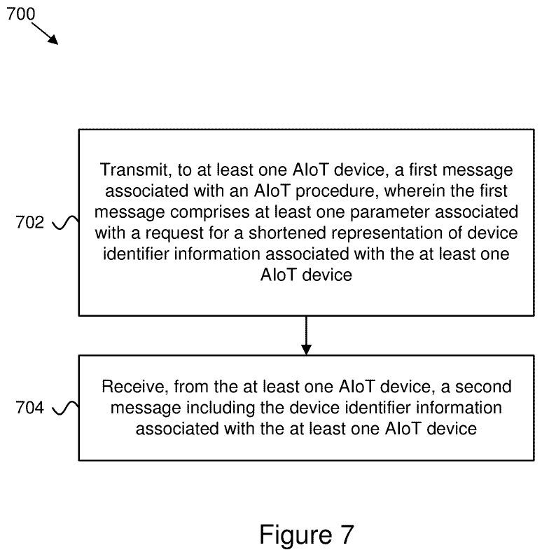

FIG. 7 illustrates a flowchart of a method 700 in accordance with aspects of the present disclosure. The operations of the method 700 may be implemented by an AIoT reader as described herein. In some implementations, the AIoT reader may execute a set of instructions to control the function elements of a processor to perform the described functions. It should be noted that the method described herein describes a possible implementation, and that the operations and the steps may be rearranged or otherwise modified and that other implementations are possible.

At 702, the method may include transmitting, to at least one AIoT device, a first message associated with an AIoT procedure, wherein the first message comprises at least one parameter associated with a request for a shortened representation of device identifier information associated with the at least one AIoT device. The operations of 702 may be performed in accordance with examples as described herein. In some implementations, aspects of the operations of 702 may be performed by a UE as described with reference to FIG. 4 or an NE as described with reference to FIG. 6.

At 704, the method may include receiving, from the at least one AIoT device, a second message including the device identifier information associated with the at least one AIoT device. The operations of 704 may be performed in accordance with examples as described herein. In some implementations, aspects of the operations of 704 may be performed by a UE as described with reference to FIG. 4 or an NE as described with reference to FIG. 6.

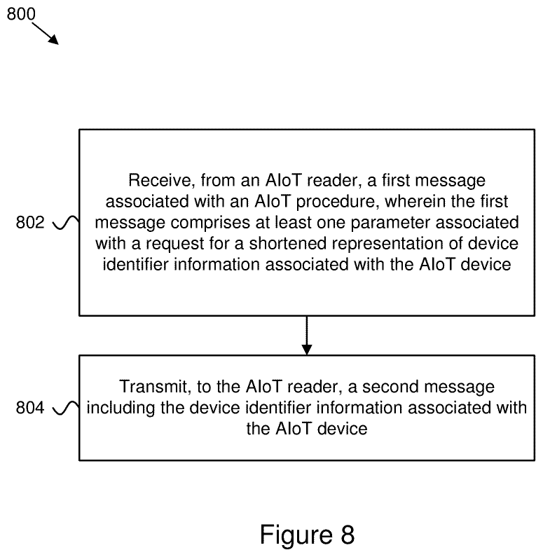

FIG. 8 illustrates a flowchart of a method 800 in accordance with aspects of the present disclosure. The operations of the method 800 may be implemented by an AIoT device as described herein. In some implementations, the AIoT device may execute a set of instructions to control the function elements of a processor to perform the described functions. It should be noted that the method described herein describes a possible implementation, and that the operations and the steps may be rearranged or otherwise modified and that other implementations are possible.

At 802, the method may include receiving, from an AIoT reader, a first message associated with an AIoT procedure, wherein the first message comprises at least one parameter associated with a request for a shortened representation of device identifier information associated with the AIoT device. The operations of 802 may be performed in accordance with examples as described herein. In some implementations, aspects of the operations of 802 may be performed by a UE as described with reference to FIG. 4 or an NE as described with reference to FIG. 6.

At 804, the method may include transmitting, to the AIoT reader, a second message including the device identifier information associated with the AIoT device. The operations of 804 may be performed in accordance with examples as described herein. In some implementations, aspects of the operations of 804 may be performed by a UE as described with reference to FIG. 4 or an NE as described with reference to FIG. 6.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An ambient internet of things (AIoT) reader, comprising:
at least one memory; and
at least one processor coupled with the at least one memory and configured to cause the AIoT reader to:
transmit, to at least one AIoT device, a first message associated with an AIoT procedure, wherein the first message comprises at least one parameter associated with a request for a shortened representation of device identifier information associated with the at least one AIoT device; and
receive, from the at least one AIoT device, a second message including the device identifier information associated with the at least one AIoT device.

2. The AIoT reader of claim 1, wherein the at least one parameter indicates a length of the device identifier information, or a type of the device identifier information, or both, and wherein the shortened representation of the device identifier information associated with the at least one AIoT device is based at least in part on the at least one parameter.

3. The AIoT reader of claim 1, wherein the second message includes the shortened representation of the device identifier information associated with the at least one AIoT device based at least in part on the at least one parameter, and
wherein the shortened representation of the device identifier information associated with the at least one AIoT device comprises a truncated form of the device identifier information associated with the at least one AIoT device.

4. The AIoT reader of claim 1, wherein the second message includes a full representation of the device identifier information associated with the at least one AIoT device based at least in part on the at least one parameter, and
wherein the full representation of the device identifier information associated with the at least one AIoT device comprises a non-truncated form of the device identifier information associated with the at least one AIoT device.

5. The AIoT reader of claim 1, wherein the device identifier information comprises an identification information in an AIoT device permanent identifier.

6. The AIoT reader of claim 1, wherein the first message comprises a paging message.

7. The AIoT reader of claim 1, wherein the at least one processor is configured to cause the AIoT reader to receive the at least one parameter from an AIoT network device.

8. The AIoT reader of claim 7, wherein the AIoT network device is an AIoT function (AIOTF) or an application function (AF).

9. A method performed by an ambient internet of things (AIoT) reader, the method comprising:
transmitting, to at least one AIoT device, a first message associated with an AIoT procedure, wherein the first message comprises at least one parameter associated with a request for a shortened representation of device identifier information associated with the at least one AIoT device; and
receiving, from the at least one AIoT device, a second message including the device identifier information associated with the at least one AIoT device.

10. The method of claim 9, further comprising receiving the at least one parameter from an AIoT network device.

11. The method of claim 10, wherein the AIoT network device is an AIoT function (AIOTF) or an application function (AF).

12. An ambient internet of things (AIoT) device, comprising:
at least one memory; and
at least one processor coupled with the at least one memory and configured to cause the AIoT device to:
receive, from an AIoT reader, a first message associated with an AIoT procedure, wherein the first message comprises at least one parameter associated with a request for a shortened representation of device identifier information associated with the AIoT device; and
transmit, to the AIoT reader, a second message including the device identifier information associated with the AIoT device.

13. The AIoT device of claim 12, wherein the at least one parameter indicates a length of the device identifier information, or a type of the device identifier information, or both, and wherein the shortened representation of the device identifier information associated with the AIoT device is based at least in part on the at least one parameter.

14. The AIoT device of claim 12, wherein the second message includes the shortened representation of the device identifier information associated with the AIoT device based at least in part on the at least one parameter, and
wherein the shortened representation of the device identifier information associated with the AIoT device comprises a truncated form of the device identifier information associated with the AIoT device.

15. The AIoT device of claim 12, wherein the second message includes a full representation of the device identifier information associated with the AIoT device based at least in part on the at least one parameter, and
wherein the full representation of the device identifier information associated with the AIoT device comprises a non-truncated form of the device identifier information associated with the AIoT device.

16. The AIoT device of claim 12, wherein the device identifier information comprises an identification information in an AIoT device permanent identifier.

17. The AIoT device of claim 12, wherein the first message comprises a paging message.

18. The AIoT device of claim 12, wherein the at least one processor is configured to cause the AIoT device to truncate the device identifier information into the shortened representation of the device identifier information.

19. The AIoT device of claim 13, wherein the device identifier information is truncated starting from a least significant bit (LSB) or a most significant bit (MSB).

20. A method performed by an ambient internet of things (AIoT) device, the method comprising:
receiving, from an AIoT reader, a first message associated with an AIoT procedure, wherein the first message comprises at least one parameter associated with a request for a shortened representation of device identifier information associated with the AIoT device; and
transmitting, to the AIoT reader, a second message including the device identifier information associated with the AIoT device.
